(19) United States
(12) Patent Application Publication
(10) Pub. No.: US 2026/0061766 A1
(43) Pub. Date: Mar. 5, 2026

(54) PRINTING APPARATUS

(71) Applicant: CANON KABUSHIKI KAISHA, Tokyo (JP)

(72) Inventor: AKIHIRO TOMIDA, Kanagawa (JP)

(21) Appl. No.: 19/309,926

(22) Filed: Aug. 26, 2025

(30) Foreign Application Priority Data
Sep. 3, 2024 (JP) 2024-151303

(51) Int. Cl. B41J 29/377; B41J 2/045; B41J 2/175; B41J 2/18; B41J 11/00

(52) U.S. Cl. CPC B41J 29/377; B41J 2/04553; B41J 2/04563; B41J 2/17523; B41J 2/17596; B41J 2/18; B41J 11/002; B41J 2/04586

(57) ABSTRACT

Change in properties of a liquid after completion of a printing operation is suppressed. A printing apparatus includes: a printing head; a liquid reservoir unit; a supply passage; a circulation flow passage; a circulation drive unit; a ventilation unit; a first temperature detection unit configured to detect a temperature of the printing unit; a second temperature detection unit configured to detect a temperature of the liquid in the circulation flow passage; and a control unit configured to control the circulation drive unit and the ventilation unit. When a difference between the temperature detected by the first temperature detection unit and the temperature detected by the second temperature detection unit is equal to or more than a first temperature difference, and a first time has not elapsed from completion of a printing operation of the printing head, the control unit drives the circulation drive unit and the ventilation unit.

### BACKGROUND

### Field of the Technology

The present disclosure relates to a printing apparatus.

### Description of the Related Art

In a printing apparatus, there is a case where a control adapted to the temperature around the apparatus is conducted.

In a printing apparatus using an inkjet system, a circulation flow passage configuration for an ink is used as configurations for maintaining an ejection stability of a printing head which is continuously driven. In circulation flow passages for an ink, the ink is circulated between the insides of the nozzles and a reservoir unit. In this case, a method for stably ejecting the ink by controlling the temperature at a constant level by using a heat exchanger or the like has been proposed. Japanese Patent Laid-Open No. 2012-51347 discloses a temperature control method based on a temperature in a circulation flow passage and an ambient temperature during printing.

According to the printing apparatus of Japanese Patent Laid-Open No. 2012-51347, a condensation preventive measure adapted to an environment around an apparatus is achieved.

Meanwhile, even in the case where the printing apparatus is stopped immediately after the completion of a printing operation, the temperature of a heat source which is driven while the printing apparatus is conducting the printing operation does not decrease immediately. For this reason, there is a case where a high-temperature state continues in and around the printing apparatus after the completion of the printing operation. If the high-temperature state continues for a long time after the completion of a printing operation, there is a possibility that the liquid present inside the printing apparatus is heated, so that the properties of the liquid change.

### SUMMARY

A printing apparatus has: a printing head including a printing element configured to generate an energy for ejecting a liquid; a liquid reservoir unit configured to reserve the liquid; a supply passage configured to supply the liquid from the liquid reservoir unit to the printing head; a circulation flow passage configured to include at least part of the supply passage, supply the liquid from the liquid reservoir unit to the printing head through the supply passage, and cause the liquid passed through the print head to again pass through the supply passage; a circulation drive unit configured to circulate the liquid in the circulation flow passage; a ventilation unit configured to ventilate an atmosphere inside a printing unit provided with the printing head and the circulation flow passage; a first temperature detection unit configured to detect a temperature of the printing unit; a second temperature detection unit configured to detect a temperature of the liquid in the circulation flow passage; and a control unit configured to control drive of the circulation drive unit and drive of the ventilation unit, wherein in a case where a difference between the temperature detected by the first temperature detection unit and the temperature detected by the second temperature detection unit is equal to or more than a first temperature difference, and a first time has not elapsed from completion of a printing operation of the printing head, the control unit drives the circulation drive unit and the ventilation unit.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view showing an internal configuration of a printing apparatus of an embodiment.

FIG. 2 is a block diagram of the printing apparatus of an embodiment.

FIG. 3 is a diagram showing a configuration around a printing unit of an embodiment.

FIG. 4 is a schematic diagram showing a configuration of an ink supply passages of an embodiment.

FIG. 5 is a diagram showing a head ascending and descending mechanism of an embodiment.

FIG. 6 is a graph showing Reference Example of transitions of output values of a first temperature sensor and a second temperature sensor.

FIG. 7 is a flowchart showing a cooling operation determination method of an embodiment.

FIG. 8 is a diagram showing an example of a subroutine of S705.

FIG. 9A is a graph showing a temperature transition in the case where a circulation flow passage temperature TI is lower than an environmental temperature TE.

FIG. 9B is a graph showing a temperature transition in the case where the circulation flow passage temperature TI is equal to or more than the environmental temperature TE.

FIG. 10 is a schematic sectional view showing an internal configuration of a printing apparatus of an embodiment.

FIG. 11 is a diagram showing a modification of the subroutine of S705.

### DESCRIPTION OF THE EMBODIMENTS

### First Embodiment

### Printing Apparatus 1

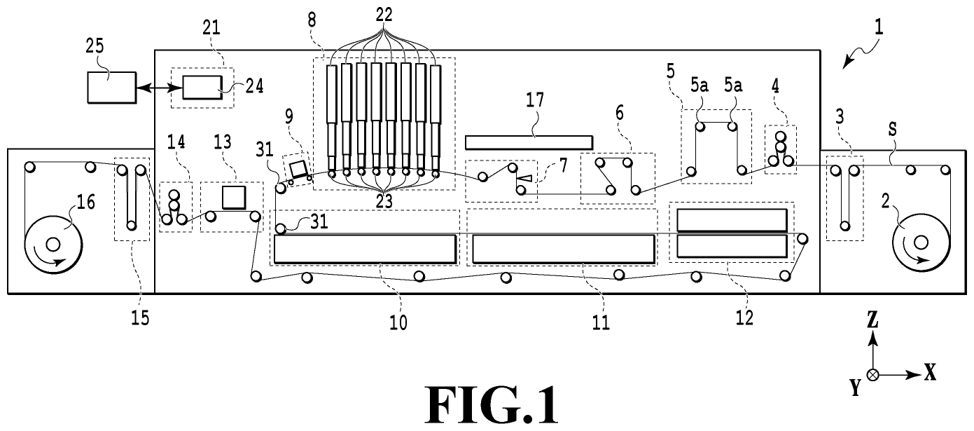

FIG. 1 is a schematic sectional view showing an internal configuration of a printing apparatus 1. A vertical direction (a height direction) in FIG. 1 is defined as a Z-direction, a lateral direction (a longitudinal direction) in FIG. 1 is defined as an X direction, and a direction orthogonal to the height direction and the longitudinal direction (that is, a direction from the front to the back of the sheet surface in FIG. 1) is defined as a Y-direction. In addition, a line printer configured to print an image on a printing medium S wound in a roll shape by using inks will be described below. However, the technology of the present disclosure can be applied to not only an apparatus using a printing medium S wound in a roll shape, but also a line printer configured to print an image on a cut sheet.

In the present disclosure, the term “printing” does not mean only forming significant information (for example, a text, a figure, or the like which is so visualized that it can be visually perceived by humans). The term “printing” also means forming insignificant information. Moreover, in the present disclosure, the term “printing” also broadly means forming an image, a design, a pattern, a structure, combinations of these, or the like on a printing medium, or processing a medium.

In addition, the term “printing medium” includes not only the above-mentioned sheet, but also those capable of receiving an ink such as cloth, plastic films, metal plates, glass, ceramics, resins, wood, leather, and the like. That is, the printing medium S is not limited as long as printing can be conducted thereon.

As shown in FIG. 1, the printing apparatus 1 includes an unwinding roll unit 2, a first dancer unit 3, a first main conveyance unit 4, a meandering correction unit 5, a conveyance detection unit 6, a mark sensor unit 7, and a printing unit 8 therein. The printing apparatus 1 includes a first scanner unit 9, a first drying unit 10, a second drying unit 11, a cooling unit 12, a second scanner unit 13, a second main conveyance unit 14, a second dancer unit 15, a winding roll unit 16, and a maintenance tray 17 as subsequent units of the printing unit 8. The printing medium S is conveyed along a conveyance passage indicated by a solid line in FIG. 1. The printing medium S is processed in each aforementioned unit.

The printing apparatus 1 includes an apparatus control unit 21 which collectively controls the operation of the printing apparatus 1. The apparatus control unit 21 includes an operation unit 24 which receives operations from the user. The operation unit 24 is configured to be capable of transmitting and receiving various pieces of information to and from a host apparatus 25 provided outside the printing apparatus 1.

The unwinding roll unit 2 is a unit for holding and feeding the printing medium S wound in a roll shape. The unwinding roll unit 2 is configured to be capable of housing an unwinding roll and drawing and feeding the printing medium S. Note that in the present embodiment, one roll can be housed. However, the number of rolls which can be housed is not limited to one. The unwinding roll unit 2 may be configured to be capable of housing two or three or more rolls, and drawing and feeding the printing medium S selectively from the plurality of rolls.

The first dancer unit 3 is a unit for applying a certain tension between the unwinding roll unit 2 and the first main conveyance unit 4. In the first dancer unit 3, the tension is applied by a tension application unit which is not shown.

The first main conveyance unit 4 is a unit for sending the printing medium S to the following units, and applying a predetermined tension to the printing medium S in cooperation with the second main conveyance unit 14. The first main conveyance unit 4 is rotated by driving a motor, which is not shown, and conveys the printing medium S while applying the tension to the printing medium S.

The meandering correction unit 5 is a unit for correcting the meandering of the printing medium S in the Y-direction while the printing medium S to which the tension has been applied is conveyed. The meandering correction unit 5 includes meandering correction rollers 5a and a meandering detection sensor for detecting the meandering of the printing medium S, which is not shown. The meandering correction rollers 5a are capable of changing the inclination of the printing medium S by using a motor, which is not shown, and correct the meandering of the printing medium S based on a result of measurement of the meandering detection sensor. In this event, the printing medium S is wound around the meandering correction rollers 5a, so that the function of correcting the meandering can be enhanced. The meandering correction unit 5 allows the conveyance direction of the meandering printing medium S to return to a normal conveyance direction.

The conveyance detection unit 6 is a unit for detecting a tension during the conveyance of the printing medium S to which the tension is applied between the first main conveyance unit 4 and the second main conveyance unit 14. In addition, the conveyance detection unit 6 is also a unit for detecting the speed of the printing medium S in order to control the printing timing of the printing unit 8.

The mark sensor unit 7 is a unit for detecting a mark printed on the printing medium S in advance in order to control the printing timing of the printing unit 8.

The printing unit 8 is a unit for printing the conveyed printing medium S. The printing unit 8 prints an image by conducting ink ejection processing on the printing medium S by using printing heads 22 from above. The conveyance passage in the printing unit 8 is formed with a plurality of guide rollers 23 arranged to form an arc shape bulging upward. In the conveyance passage in the printing unit 8, a certain tension is applied to the printing medium S, so that a clearance with the printing heads 22 is ensured.

A plurality of printing heads 22 are arranged side by side along the conveyance direction. In the present embodiment, the printing apparatus 1 includes eight line-type printing heads in total which correspond to four colors of Bk (black), Y (yellow), M (magenta), and C (cyan) as well as a reaction liquid and three particular colors.

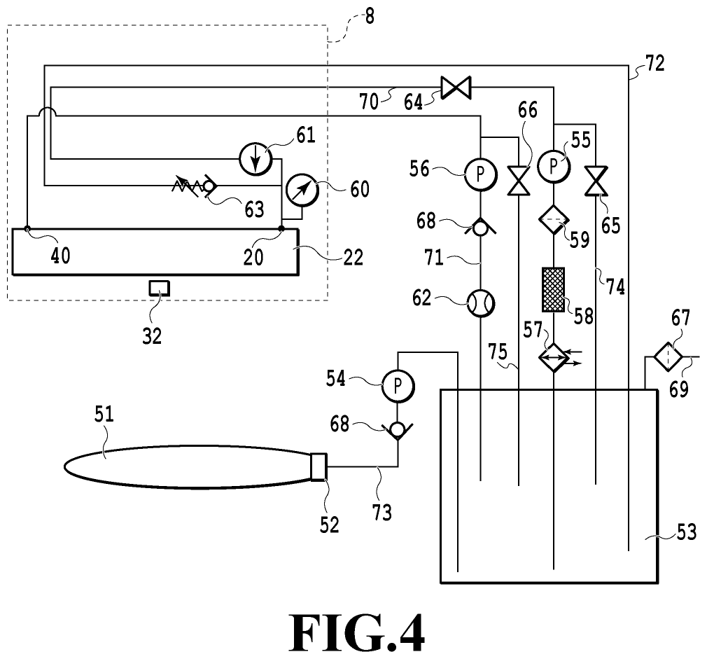

Note that the number of colors is not limited to four. The number of printing heads is not limited to eight. As the inkjet system to be applied to the printing heads 22, a system using heating elements, a system using piezoelectric elements, a system using electrostatic elements, a system using MEMS elements, or the like can be employed. The ink of each color is supplied from a corresponding ink pack 51 (see FIG. 4) to the printing head 22 via an ink tube.

The first scanner unit 9 is a unit for reading an image printed on the printing medium S by the printing unit 8, and detecting displacement and concentration of the image. The result of detection by the first scanner unit 9 is used for correction. For example, the result of detection by the first scanner unit 9 is used to correct the position and correct the color tone.

The first drying unit 10 and the second drying unit 11 are units for reducing liquid contents contained in the inks applied onto the printing medium S by the printing unit 8, and enhancing the fixation between the printing medium S and the inks. The second drying unit 11 is disposed downstream of the first drying unit 10 in the conveyance direction of the printing medium S. The first drying unit 10 and the second drying unit 11 heat the printed printing medium S to dry the applied inks. Inside the first drying unit 10 and the second drying unit 11, hot air is applied to the printing medium S passing therethrough at least from the ink application surface side to dry the ink application surface.

Note that the drying system is not limited to a system of applying hot air. Besides, a system of irradiating the surface of the printing medium S with an electromagnetic wave (an ultraviolet ray, an infrared ray, or the like) and a conductive heat transfer system by methods of contact of a heat generating body may be combined.

Winding guide rollers 31 are rollers which wind a surface of the printing medium S on the opposites side to the ink application surface at a certain winding angle on the downstream side of the printing unit 8 in the conveyance direction. This configuration can shut down the hot air generated by the first drying unit 10 and suppress the influence of the hot air on the printing unit 8. In the present embodiment, two winding guide rollers 31 are disposed between the first scanner unit 9 and the first drying unit 10. The printing medium S is turned back such that portions of the printing medium S on the upper and lower sides of the apparatus become substantially in parallel. The first drying unit 10 is disposed below the printing unit 8. The second drying unit 11 is disposed below the conveyance detection unit 6 and the mark sensor unit 7.

The cooling unit 12 cools down the printing medium S on which the inks have been fixed by the first drying unit 10 and the second drying unit 11 to solidify the softened inks and suppress change in temperature of the printing medium S over the steps of the respective units downstream in the conveyance direction of the printing apparatus 1. Inside the cooling unit 12, air at a temperature lower than the printing medium S is applied to the printing medium S passing therethrough at least from the ink application surface side to cool down the ink application surface of the printing medium S. Note that the cooling system is not limited to a system of applying air. The cooling system may be a conductive heat transfer system by means of contact of a heat dissipation member. The cooling system may be configured by combining a system of applying air and a conductive heat transfer system by means of contact of a heat dissipation member.

The second scanner unit 13 is a unit for reading a test image printed on the printing medium S by the printing unit 8 before real printing, and detecting displacement and concentration of the image. The result of detection by the second scanner unit 13 is used for correction in the real printing after the printing of the test image.

The second main conveyance unit 14 functions by operating together with the first main conveyance unit 4. The second main conveyance unit 14 is a unit for conveying the printing medium S while applying a tension to the printing medium S, and adjusting the tension of the printing medium S. The second main conveyance unit 14 is driven to rotate by a motor, which is not shown. The tension of the printing medium S is adjusted by a clutch (not shown) which is coupled to drive and can control torque based on a tension value detected by a tension control unit, which is not shown.

Note that as additional configuration for adjusting the tension of the printing medium S, a configuration of controlling the speed of the second main conveyance unit 14 based on the result of detection by the conveyance detection unit 6 may be added. As the method for achieving this configuration, it can be considered to use any of a torque control method for controlling the value of the torque transmitted from the clutch and a speed control method for controlling the roller speed of the second main conveyance unit 14. Alternatively, these two methods may be used in a switching manner in accordance with the object, or both may be used simultaneously.

The second dancer unit 15 is a unit for applying a certain tension between the second main conveyance unit 14 and the winding roll unit 16. In the second dancer unit 15, the certain tension is applied to the printing medium S by a tension application unit, which is not shown.

The winding roll unit 16 is a unit for winding the printing medium S on which printing has been made around a winding core. Note that although one roll can be collected in FIG. 1, the number of rolls which can be collected is not limited to one. The winding roll unit 16 may be configured to be capable of collecting the printing medium S by selectively switching two or three or more winding cores. Note that depending on the content of the processing after the printing, it is unnecessary to wind the printing medium S around the winding core. For example, a configuration in which the printing medium S is cut by using a cutter, and the printing medium S thus cut is stacked may be employed.

The maintenance tray 17 is a unit including a mechanism for collecting an ejection performance of the printing head 22. Examples of such a mechanism include a cap mechanism which protects the ink ejection surface of the printing head 22, a wiper mechanism which wipes the ink ejection surface by using a blade or the like (a so-called wiping mechanism), a suction mechanism which sucks the ink inside the nozzles from the ink ejection surface with a negative pressure, and the like.

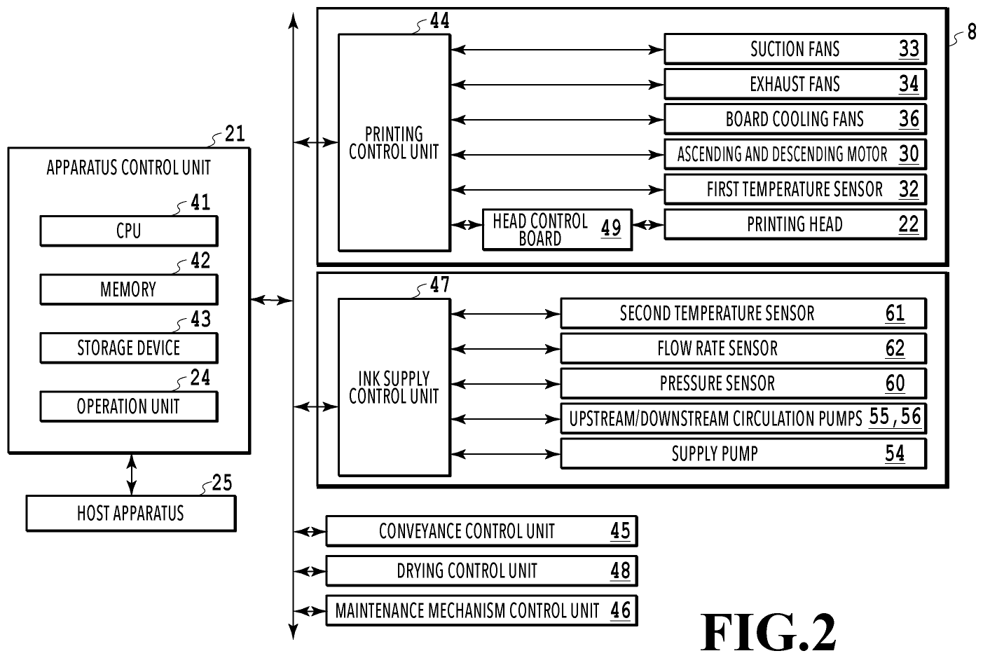

FIG. 2 is a block diagram of a control unit for controlling each unit of the printing apparatus 1.

As shown in FIG. 2, the apparatus control unit 21 includes a CPU 41, a memory 42, a storage device 43, and an operation unit 24. The operation unit 24 includes an I/F for communicating with a control unit of each individual unit, and an external I/F for connecting to a host apparatus 25 such as an external host computer. Upon receipt of an instruction from the host apparatus 25 or the operation unit 24, the apparatus control unit 21 transmits a control instruction to each unit of the printing apparatus 1. A control program and control parameters for executing the control instruction are stored in the memory 42 or the storage device 43. The CPU 41 reads these control program and control parameters and executes the control program.

In the present embodiment, the first temperature sensor 32 detects the temperature of the printing unit 8 (the “head temperature TP” which will be described later) in real-time. The first temperature sensor 32 may detect the humidity of the printing unit 8 together with the temperature of the printing unit 8 in real-time. The second temperature sensor 61 detects the temperature of the ink inside circulation flow passages (which will be described later) in real-time. Then, information indicating the transitions of these temperatures is stored in the memory 42. That is, in the memory 42, information indicating the temperatures of the first temperature sensor 32 and the second temperature sensor 61 for a predetermined time (for example, a second time (tmin) which will be described later) is accumulated. Note that these pieces of information may be stored in the storage device 43 (see FIG. 2).

A printing control unit 44 starts a printing preparation operation based on a printing instruction received from the apparatus control unit 21. At this time, a conveyance control unit 45 which conveys the printing medium S controls each drive unit such that the printing medium S is conveyed at a designated conveyance speed, and a maintenance mechanism control unit 46 moves the printing head 22 away from a cap (not shown), and moves the maintenance tray 17 to a retreat position. Moreover, a drying control unit 48 controls the first drying unit 10, the second drying unit 11, and the cooling unit 12 (see FIG. 1) such that these have designated temperatures. An ink supply control unit 47 drives an upstream circulation pump 55 and a downstream circulation pump 56 for circulating the ink, and feeds back the results of detections of a pressure sensor 60 and a flow rate sensor 62 to adjust driving amounts of the upstream circulation pump 55 and the downstream circulation pump 56. Hereinafter, in the case where there is no need to particularly distinguish the upstream circulation pump 55 and the downstream circulation pump 56, these are referred to as “circulation pumps”. After the above preparation operation has been completed, the printing control unit 44 moves the printing head 22 down to a printing position. Thereafter, printing data generated in the apparatus control unit 21 is converted to a drive signal for the printing head 22 in a head control board 49 of each color, and a drive voltage is applied to drive the printing elements.

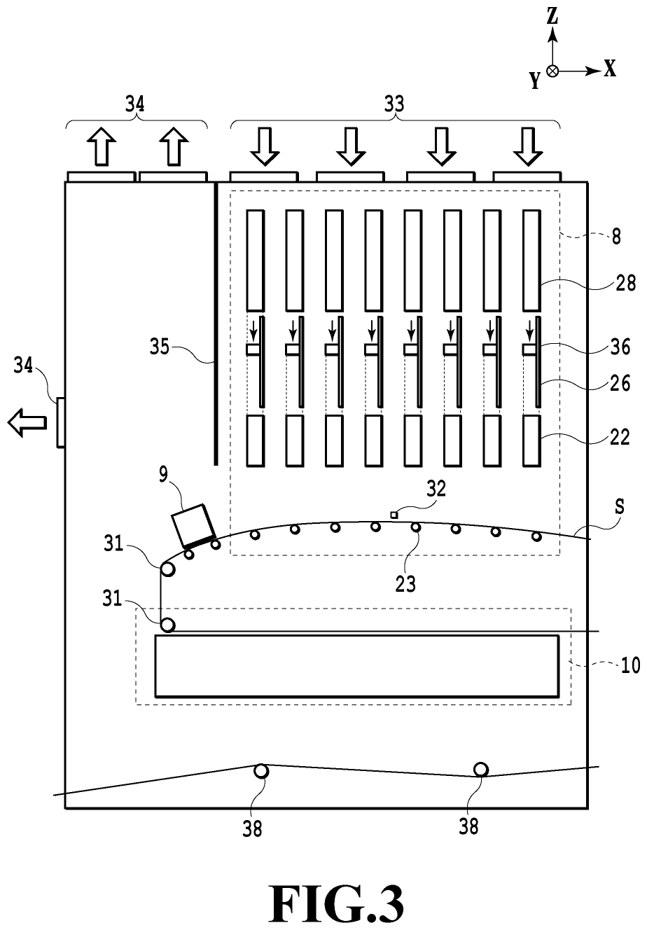

FIG. 3 is a diagram showing a configuration around the printing unit 8 in the printing apparatus 1.

As shown in FIG. 3, the printing unit 8 includes printing head holding units 26 on which the printing heads 22 are mounted in the upper portions, and ascending and descending frames 28. Below these, the first drying unit 10 is disposed. In the lowermost stage, conveyance rollers 38 which convey the printing medium S after passing through the second drying unit 11 and the cooling unit 12 are disposed. Around the printing unit 8, not only the temperature increases due to exhaust heat propagating from the first drying unit 10, but also the temperature increases due to heat generation of the head control board 49 (see FIG. 2) provided for the printing head holding units 26. For this reason, a ventilation mechanism including suction fans 33 and exhaust fans 34 for ventilating the atmosphere around the printing unit 8 is provided. Hereinafter, in the case where there is no need to particularly distinguish the suction fans 33 and the exhaust fans 34, these are referred to as a “fan” as appropriate.

Moreover, in order to cool down the head control board 49, board cooling fans 36 are included in the printing head holding units 26. In addition, in order to efficiently cool down the inside of the apparatus, a partition member 35 is provided between the printing unit 8 and the exhaust fans 34. According to this configuration, the atmosphere taken in from the outside by the suction fans 33 passes through the printing unit 8, and is guided to the exhaust fans 34. Moreover, in order to detect the temperature and humidity around the printing unit 8 during the printing operation to maintain an appropriate environment, the first temperature sensor 32 is disposed near the guide rollers 23 which convey the printing medium S.

Note that the hot air of the first drying unit 10 and the second drying unit 11 (see FIG. 1) is exhausted from exhaust ports included therein. For this reason, the temperature is not influenced by the entry of the hot air into the printing unit 8. As the temperature of each of the first drying unit 10 and the second drying unit 11 increases, the temperature inside the printing apparatus 1 increases as a whole.

FIG. 4 is a schematic diagram showing a configuration of an ink supply passage of the present embodiment.

As shown in FIG. 4, a supply passage 73 which supplies the ink from the ink pack 51 to a buffer tank 53 is provided. The supply pump 54 included in the supply passage 73 is driven to supply the ink reserved inside the ink pack 51 to the inside of the buffer tank 53. The ink pack 51 of the present embodiment reserves the ink in an aluminum pillow bag. One end of the supply passage 73 is connected to a supply port included in the ink pack 51 via a joint 52.

Note that a cover member which covers the ink pack 51 may be provided. Although in the present embodiment, the form of the ink pack 51 is a pillow form, the form of the ink pack 51 is not limited to this form. For example, the form of the ink pack 51 may be a tank form or a bottle form. In addition, although in the present embodiment, the material of the ink pack 51 is aluminum, the material of the ink pack 51 is not limited to aluminum. For example, the material of the ink pack 51 may be polypropylene or the like.

The buffer tank 53 is a container for reserving the ink. In order to suppress a fluctuation in pressure associated with an increase or decrease of the ink inside the ink supply passages, an atmosphere communication passage 69 is connected to the buffer tank 53. In order to suppress the entry of a foreign matter such as dust contained in the case of taking the atmosphere into the inside of the buffer tank 53, the atmosphere communication passage 69 includes an air filter 67.

A circulation upstream flow passage 70 which supplies the ink to the printing head 22 and a circulation downstream flow passage 71 which causes the ink to return from the printing head 22 to the buffer tank 53 are connected to the buffer tank 53. Hereinafter, the circulation upstream flow passage 70 and the circulation downstream flow passage 71 are collectively referred to as a “circulation flow passage” as appropriate. The ink supplied to the buffer tank 53 is sent to the printing head 22 by the upstream circulation pump 55 included in the circulation upstream flow passage 70. A heat exchanger 57, a deaeration module 58, and a filter 59 are provided between the buffer tank 53 and the upstream circulation pump 55.

The heat exchanger 57 is a device for conducting temperature adjustment on the ink by using circulation water having a certain temperature which is supplied from a chiller (not shown) installed outside the printing apparatus 1, in order to keep the temperature of the ink supplied from the buffer tank 53 to the printing head 22 constant.

The deaeration module 58 is a device which discharges a gas dissolved inside the ink to a gas chamber which is reduced in pressure at an interface with a gas-liquid exchange membrane when the ink passes through the inside. This makes it possible to reduce a gas dissolved inside the ink.

The filter 59 traps aggregates derived from foreign matters (fragments of members or dirt in the flow passage) contained in the ink and the component (a pigment or a solid such as a resin) of the ink. This makes it possible to suppress the clogging of the nozzles in the printing head 22.

Note that in the present embodiment, the number of the upstream circulation pump 55 is one. However, the number of the upstream circulation pump 55 is not limited to one. A plurality of the upstream circulation pumps 55 may be provided side by side in parallel. The order of connection of the heat exchanger 57, the deaeration module 58, and the filter 59 is not limited to this order.

As the ink is sent from the upstream circulation pump 55, the circulation upstream flow passage 70 is pressurized, so that the ink is supplied to the printing head 22. However, if an excessive pressure is applied to a head supply port 20 provided in the printing head 22, there is a possibility that a pressure control valve provided inside the printing head 22 is opened to cause the ink to leak from the nozzles. For this reason, a relief flow passage 72 including a relief valve 63 is provided before the head supply port 20. This allows the excessively supplied ink to return to the buffer tank 53 via the relief flow passage 72.

In addition, in the case where the circulation of the ink is stopped as well, the circulation upstream flow passage 70 is brought into a pressurized state. There is a possibility that continuous application of the pressure causes the ink to leak from the inside of the flow passage. In order to suppress this, one end of an upstream pressure release flow passage 74 is connected downstream of the upstream circulation pump 55, and the other end of the upstream pressure release flow passage 74 is connected to the buffer tank 53. According to this configuration, at the time when the circulation is stopped, an upstream-side pressure release valve 65 provided in the upstream pressure release flow passage 74 is opened to release the pressure inside the circulation upstream flow passage 70. This makes it possible to suppress the leakage of the ink from the inside of the flow passage at the time when the circulation is stopped.

In addition, in the relief flow passage 72, the second temperature sensor 61 and the pressure sensor 60 are provided before the head supply port 20. The second temperature sensor 61 measures the temperature of the ink to be supplied to the printing head 22 (a “circulation flow passage temperature TI” which will be described later). The pressure sensor 60 measures the pressure of the ink to be supplied to the printing head 22. Based on the results of these measurements, the driving amount of the upstream circulation pump 55 is adjusted, and the pressure and the temperature of the ink to be supplied to the printing head 22 are controlled to be maintained at constant levels. One end of the circulation downstream flow passage 71 which cause the ink to return to the buffer tank 53 is connected to a head discharge port 40 provided in the printing head 22. The downstream circulation pump 56 is included in the middle of the circulation downstream flow passage 71.

In addition, the flow rate sensor 62 is provided downstream of the downstream circulation pump 56. The flow rate sensor 62 detects the amount of the ink discharged from the printing head 22 by the drive of the downstream circulation pump 56. This makes it possible to monitor the amount of the ink flowing inside the circulation flow passage and to control the flow rate by adjusting the driving amount of the downstream circulation pump 56.

In addition, by providing the flow rate sensor 62 in the circulation downstream flow passage 71, it becomes possible to measure a circulation flow rate obtained by subtracting the amount of the ink to be used for printing an image from the printing head 22.

In addition, the other end of the circulation downstream flow passage 71 is connected to the buffer tank 53. In the circulation downstream flow passage 71, one end of a downstream pressure release flow passage 75 including a downstream-side pressure release valve 66 is connected between the head discharge port 40 and the downstream circulation pump 56. The other end of the downstream pressure release flow passage 75 is connected to the buffer tank 53. The downstream-side pressure release valve 66 is configured to be capable of releasing the pressure in the flow passage provided closer to the downstream circulation pump 56 on the printing head 22 side at the time of non-circulation. This makes it possible to suppress application of an excessive negative pressure in the circulation downstream flow passage 71 which breaks a meniscus formed in the nozzles in the printing head 22 to cause air to enter.

An ink supply unit (not shown) which supplies the ink to the printing head 22 is provided only inside the printing unit 8. The buffer tank 53, the upstream circulation pump 55, the downstream circulation pump 56, and the like are provided outside the printing unit 8 so as to be hardly influenced by an increase in temperature.

According to the above flow passage configuration, the ink is circulated between the buffer tank 53 and the printing head 22. Then, the temperature of the circulated ink is kept constant, and a state where the amount of a dissolved gas is suppressed is maintained. In this way, the ejection performance of the ink is maintained at a constant level by suppressing an influence due to a fluctuation in temperature in the case of ejecting the ink from the printing head 22. Then, an ejection failure due to inhibition of the supply of the ink can be suppressed by suppressing an elution of a gas.

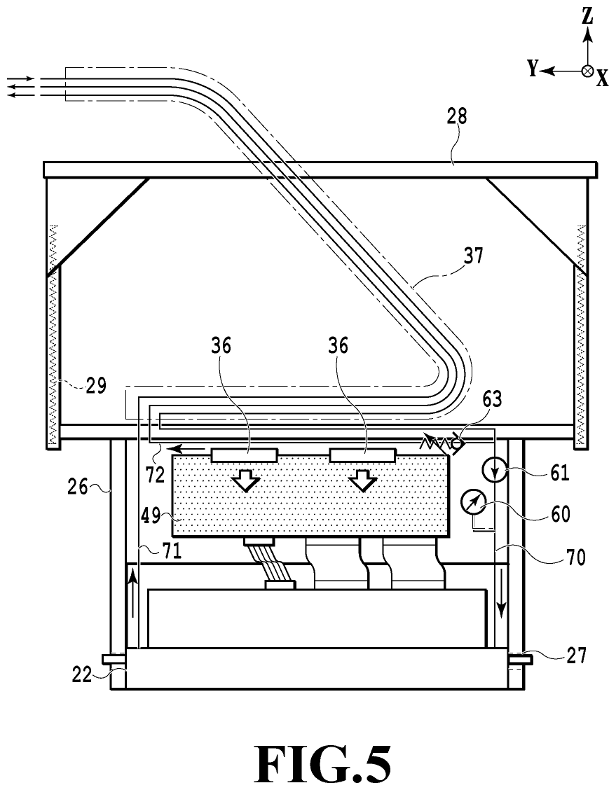

FIG. 5 is a diagram showing a head ascending and descending mechanism on which the printing head 22 is mounted, which changes the position of the printing head 22 in conformity with the printing operation.

As shown in FIG. 5, the printing head 22 is axially supported on a printing head holding unit 26 for holding and allowing the printing head 22 to vertically ascend and descend in such a manner as to support a printing head support shaft 27 from below. The printing head holding unit 26 conducts an ascending and descending operation vertically along an ascending and descending rail 29 included inside an ascending and descending frame 28 by using a drive unit including an ascending and descending motor 30 (see FIG. 2).

The circulation upstream flow passage 70, the circulation downstream flow passage 71, and the relief flow passage 72 (see FIG. 4) are connected to the printing head holding unit 26 along a circulation flow passage support member 37. At the time of ascending and descending of the printing head 22, blocking due to the buckling and twist of the flow passages is suppressed by the circulation flow passage support member 37 holding the flow passages at an appropriate curvature.

In the present embodiment, the bending angle of the circulation flow passage support member 37 is restricted by a chain link. However, the blocking due to the buckling and twist of the flow passages may be suppressed by using a metal guide member or a film-shaped member.

In the printing head holding unit 26, not only the printing head 22 but also the head control board 49, and the pressure sensor 60, the second temperature sensor 61, and the relief valve 63 on the supply passage side are disposed. Since the head control board 49 generates drive signals for driving the printing elements of the printing head 22, heat is generated in conjunction with this. The board cooling fans 36 for cooling this are provided in the printing head holding unit 26.

In the present embodiment, an image is formed by melting a thermoplastic resin contained in the ink and fixing the ink on the printing medium S (see FIG. 1) by using the hot air of the first drying unit 10 and the second drying unit 11. However, in the case where the water content contained in the ink evaporates or the temperature of the ink increases to a large extent due to drying, there is a possibility that the thermoplastic resin contained in the ink fuses to generate an aggregate.

In order to suppress this, during the printing operation in which the temperature of the printing unit 8 increases, the heat exchanger 57 (see FIG. 4) is operated to keep the temperature of the ink in the circulation flow passages constant. Then, in order to suppress an increase in temperature inside the apparatus, a cooling operation of operating the suction fans 33, the exhaust fans 34, and the board cooling fans 36 is executed. By executing the cooling operation in this way, the heat generation of the head control board 49 is contained after the completion of the printing. In addition, since the operations of the first drying unit 10 and the second drying unit 11 are also stopped, the temperature inside the apparatus gradually decreases.

However, the temperatures of the head control board 49, the first drying unit 10, and the second drying unit 11 which are increased once do not decrease immediately. For this reason, if each fan and the ink circulation are stopped early, the temperature of the ink in the circulation upstream flow passage 70, the circulation downstream flow passage 71, and the relief flow passage 72 disposed inside the printing unit 8 (see FIG. 1 and the like) keeps increasing. In particular, since in the flow passages disposed near the head control board 49, which is a heat source, the temperature of the ink increases to a large extent, there is a possibility that an aggregate is generated in the ink.

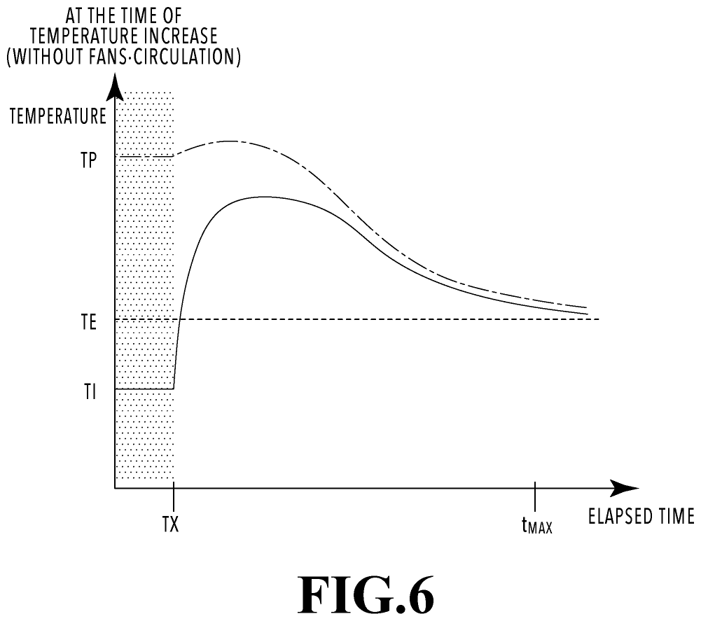

FIG. 6 is a graph showing Reference Example of transitions of output values of the first temperature sensor 32 and the second temperature sensor 61 (see FIG. 2 and the like).

In FIG. 6, a dashed line indicates the output value of the first temperature sensor 32. A solid line indicates the output value of the second temperature sensor 61. A dotted line indicates an environmental temperature TE around the printing apparatus. In the present embodiment, a sensor dedicated for detecting the environmental temperature TE is not provided. The environmental temperature TE is adjusted to be 20° C. or more and 27° C. or less.

In addition, the temperature for circulating the ink is set to 22° C. by the user in advance. Hereinafter, the temperature for circulating the ink set in advance is referred to as a “circulation setting temperature TC”.

In FIG. 6, a portion indicated by a dot pattern shows a time zone during which the cooling operation is being executed. In the example of FIG. 6, the cooling operation is executed from the time point (not shown) of starting the printing operation to the time point TX of completing the printing operation. That is, in the example of FIG. 6, after the completion of the printing operation, the cooling operation is not conducted.

During the printing operation, since the circulation via the heat exchanger 57 (see FIG. 4) is conducted, the temperature of the ink inside the circulation flow passages (hereinafter, referred to as a “circulation flow passage temperature TI”) becomes equal to the circulation setting temperature TC (for example, 22° C.). On the other hand, regarding the temperature of the printing unit 8 (see FIG. 3 and the like), the amount of generated heat and the amount of exhaust heat are brought into an equilibrium state by the driving of the fans.

During the printing operation, the temperature of the printing unit 8 (head temperature TP) is brought into a relatively high state by the heat of the head control board 49 (see FIG. 5 and the like), the first drying unit 10, and the second drying unit 11 (see FIG. 1 and the like). For example, in the case where the environmental temperature TE is 25° C., the head temperature TP becomes about 35° C. The higher the environmental temperature TE is, the higher the head temperature TP becomes. The head temperature TP also changes depending on the printing condition, the drying temperature condition, and the like.

After the printing has been completed and an image printed on the printing medium S (see FIG. 1) has arrived at the winding roll unit 16 (see FIG. 1), the drives of each heater included in each of the first drying unit 10 and the second drying unit 11 and the printing control unit 44 (see FIG. 2) stop.

After the completion of the printing operation, each heater included in the first drying unit 10 and the second drying unit 11 stops. However, in the first drying unit 10 and the second drying unit 11, heat dissipation for lowering the temperature of each heater is conducted. The first drying unit 10 and the second drying unit 11 are configured such that heat dissipated from each heater does not influence the head temperature TP.

Once the cooling operation stops along with the completion of the printing operation, the amount of ventilation decreases in the printing unit 8. Then, the propagation of heat dissipated from the head control board 49, the first drying unit 10, and the second drying unit 11 becomes predominant, so that the head temperature TP increases. Although it depends on the temperature of each heat source at the completion of the printing operation, even the largest increase in amount of the head temperature TP at the completion of the printing operation is about 10° C. or less at most.

The heat inside the printing unit 8 is discharged to the outside through the housing. For this reason, as the temperature of each heat source decreases, the head temperature TP gradually decreases to be closer to the environmental temperature TE. At this time, the circulation flow passage temperature TI also transitions in such a manner as to follow the head temperature TP via the ink circulating between the printing head 22 and the buffer tank 53. For this reason, after the completion of the printing operation, the circulation flow passage temperature TI increases to a large extent, so that there occurs a possibility that the ink aggregates as mentioned above.

In order to avoid the aggregation of the ink, it can also be considered to stop the cooling operation after the cooling operation is conducted until the temperature of the printing unit 8 decreases to some extent. However, in the printing unit 8, the first temperature sensor 32 is provided only at one location. For this reason, in the case where the temperature of a member at a position away from the first temperature sensor 32 is high, or in the case where cooling on the head control board 49 is insufficient, or in similar cases, the circulation flow passage temperature TI increases again in some cases.

In addition, by providing sensors for detecting temperatures of all the members included in the printing unit 8 and all the head control boards 49, it is possible to know the statuses of decreases of these temperatures in detail. However, this configuration requires a large number of sensors, leading to an increase in cost, complication of control, and the like.

In addition, it can be also considered to suppress temperature increases of the head temperature TP and the circulation flow passage temperature TI by continuing the cooling operation until a heat source located near the printing unit 8 is sufficiently cooled down, after the completion of the printing operation. However, in this cooling method, the cooling operation has to be excessively continued by driving fans and circulation pumps for a long time. That is, continuously conducting the cooling operation until a heat source is sufficiently cooled down leads to adverse effects such as shortening of service lives of fans and circulation pumps and an increase in power consumption. In view of this, in the present embodiment, after the printing operation has been completed, the fans and the circulation pumps are appropriately driven such that the circulation flow passage temperature TI does not increase to a large extent to suppress a fluctuation in temperature of the ink without conducting an excessive cooling operation.

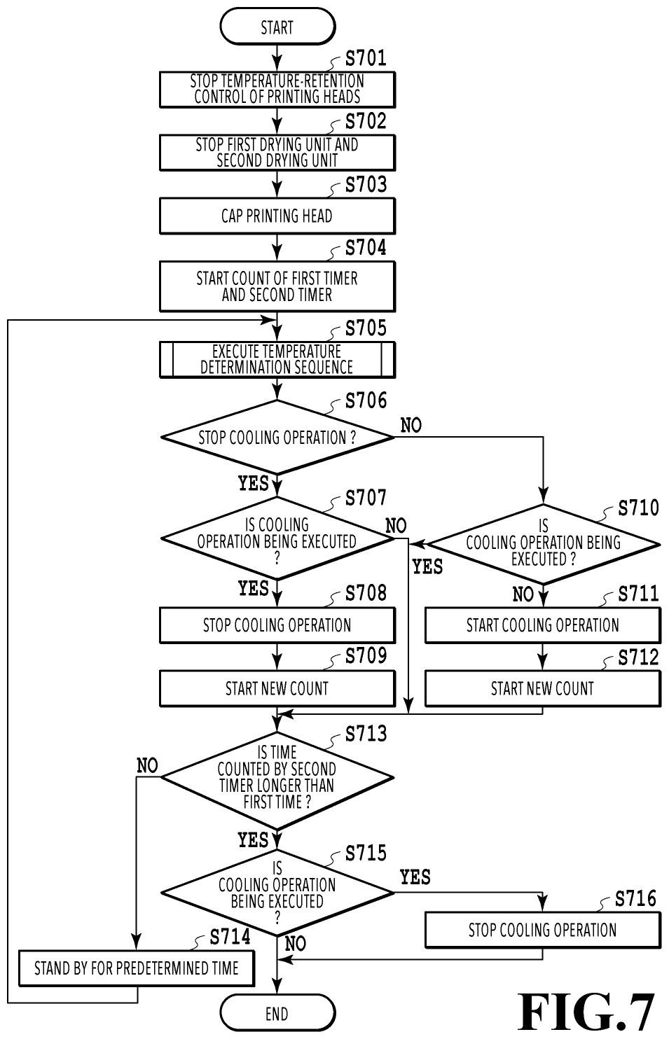

FIG. 7 is a flowchart showing a cooling method of the printing unit 8 after the completion of the printing in the present embodiment. The present flowchart is conducted by the CPU 41 developing the program code stored in the memory 42 on the storage device 43 (see FIG. 2) and executing the program code. The present flowchart is started by the completion of the printing operation as a trigger. The sign “S” in FIG. 7 means a step. Note that the same applies to the other drawings.

In S701, the CPU 41 stops the temperature-retention control of the printing heads 22 (see FIG. 2 and the like) via the head control board 49.

In S702, the CPU 41 stops the heaters of the first drying unit 10 and the heaters of the second drying unit 11 (see FIG. 1 and the like) via the drying control unit 48.

Note that in the present embodiment, after an image is formed on the printing medium S (see FIG. 1 and the like) in the printing unit 8, the portion on which the image has been formed passes through the first drying unit 10 and the second drying unit 11. For this reason, no problem occurs even in the case where the temperature-retention control of the printing head 22 is stopped before the first drying unit 10 and the second drying unit 11. For this reason, in the present embodiment, S701 is conducted before S702.

In S703, the CPU 41 caps the printing head 22. For example, the maintenance mechanism control unit 46 (see FIG. 2) moves the maintenance tray 17 (see FIG. 1) to a position at which the printing head 22 and the cap face each other. Then, the printing control unit 44 (see FIG. 2) operates the ascending and descending motor 30 to bring the printing head 22 into contact with the cap. In this way, the drying of the inks in the nozzles is suppressed.

In S704, the CPU 41 starts the count of a first timer which measures time during which the cooling operation is continuously executed or continuously stopped, and a second timer which measures an elapsed time after the printing operation is stopped. For example, the apparatus control unit 21 (see FIG. 1) sets values in the first timer and the second timer to “0”, and starts count up. A first elapsed time t1 counted by the first timer and a second elapsed time t2 counted by the second timer are stored in the memory 42. Note that these times may be stored in the storage device 43.

In S705, the CPU 41 executes a temperature determination sequence.

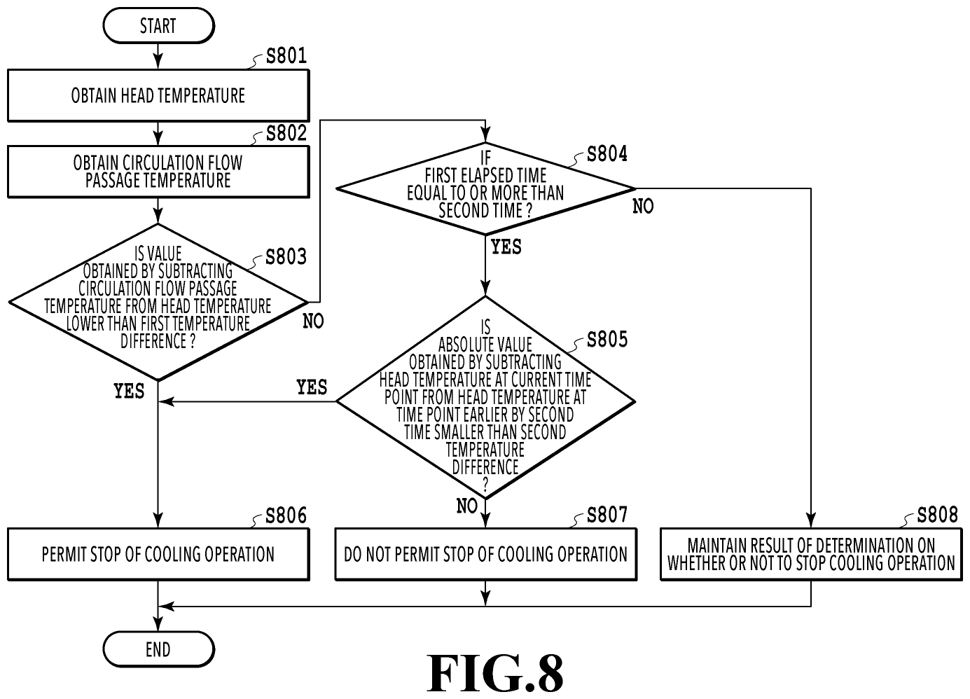

FIG. 8 is a flowchart showing a subroutine of S705.

In S801, the CPU 41 obtains the head temperature TP at the current time point which is detected by the first temperature sensor 32 (see FIG. 2) via the printing control unit 44.

In S802, the CPU 41 obtains the circulation flow passage temperature TI via the ink supply control unit 47. In the present embodiment, there are a plurality of printing heads 22 as mentioned above. In S802, the highest temperature among the circulation flow passage temperatures TI detected by the second temperature sensors 61 (see FIG. 2) provided in the circulation flow passages of the respective printing heads 22 is obtained via the ink supply control unit 47 (see FIG. 2).

In S803, the CPU 41 determines whether or not a value obtained by subtracting the circulation flow passage temperature TI obtained in S802 from the head temperature TP obtained in S801 is lower than a first temperature difference (Tth1). For example, in the case where formula 1 described below is established, the CPU 41 determines that the difference between the head temperature TP and the circulation flow passage temperature TI (see FIG. 6 and the like) is small and an influence to increase the temperature of the inks in the flow passages is small. In the present embodiment, Tth1=3° C. and it is determined whether or not the temperature obtained by subtracting the circulation flow passage temperature TI from the head temperature TP is less than 3° C.

$$TP = TI < Tth 1 \qquad ( formula 1 )$$

If the temperature difference obtained by subtracting the circulation flow passage temperature TI from the head temperature TP is equal to or more than the first temperature difference (Tth1) (NO in S803), the CPU 41 executes processing of S804. On the other hand, if the temperature difference obtained by subtracting the circulation flow passage temperature TI from the head temperature TP is less than the first temperature difference (Tth1) (YES in S803), the CPU 41 executes processing of S806.

In S804, the CPU 41 reads the memory 42, and determines whether or not the first elapsed time (t1) counted by the first timer is equal to or more than a second time (tmin). In the present embodiment, the second time (tmin) is set to 3 minutes, and the CPU 41 determines whether or not the first elapsed time (t1) is equal to or more than 3 minutes. Here, the second time corresponds to an elapsed time from the stop of printing which is required for determining the cooling state in the circulation flow passages based on the temperature transition of the printing unit.

If the first elapsed time (t1) is equal to or more than the second time (tmin) (YES in S804), the CPU 41 executes processing of S805. On the other hand, if the first elapsed time (t1) is less than the second time (tmin) (NO in S804), the CPU 41 executes processing of S808.

In S805, the CPU 41 determines whether or not an absolute value of a difference between the temperature (head temperature TP′) of the printing unit 8 at a time point which is earlier than the current time point by a second time (tmin) and the head temperature TP at the current time point is smaller than a second temperature difference Tth2. As mentioned above, information indicating the temperature transition of the printing unit 8 is stored in the memory 42. The CPU 41 reads the memory 42 to obtain the head temperature TP′, and determines whether or not an absolute value obtained by subtracting the head temperature TP obtained in S801 from the head temperature TP′ is smaller than the second temperature difference Tth2.

In the case where formula 2 described below is established, the CPU 41 determines that a difference between the head temperature TP and the circulation flow passage temperature TI is small and an influence to increase the temperature of the inks in the flow passages is small.

$$\vert {TP}^{′} - TP \vert < Tth 2 \qquad ( formula 2 )$$

In the present embodiment, the second temperature difference Tth2 is set to 0.5° C. That is, in the present embodiment, it is determined whether or not the absolute value obtained by subtracting the temperature of the printing unit 8 at the current time point from the temperature of the printing unit 8 at the time point 3 minutes earlier than the current time point is less than 0.5.

If the temperature obtained by subtracting the head temperature TP from the head temperature TP′ is less than the second temperature difference Tth2 (YES in S805), the CPU 41 executes processing of S806. On the other hand, if the temperature obtained by subtracting the head temperature TP from the head temperature TP′ is equal to or more than the second temperature difference Tth2 (NO in S805), the CPU 41 executes processing of S807.

In S806, the CPU 41 permits the stop of the cooling operation.

In S807, the CPU 41 does not permit the stop of the cooling operation.

In S808, the CPU 41 maintains a result of determination on whether or not to stop the cooling operation. Specifically, in the case where the cooling operation is being executed while the processing of S808 is being conducted, the stop of the cooling operation is not permitted, and the cooling operation is continuously executed. For example, in the first cycle of the present flowchart, there is a high possibility that the cooling operation is being executed while the processing of S808 is being conducted. Hence, in S808 in the first cycle of the present flowchart, the result of determination that the stop of the cooling operation is not permitted is maintained, and the cooling operation is continuously executed. On the other hand, in the case where the cooling operation is being stopped while the processing of S808 is being conducted, the result of determination that the stop of the cooling operation is permitted is maintained, and the state in which the cooling operation is being stopped is maintained.

After the completion of S806, S807, or S808, the CPU 41 executes processing of S706 (see FIG. 7).

In S706, the CPU 41 determines whether or not to stop the cooling operation based on the result of determination of S705, which conducted immediately before. If the stop of the cooling operation is permitted (that is, the processing conducted immediately before S706 is S806, or the result of determination that the stop of the cooling operation is permitted is maintained in S808), the CPU 41 executes processing of S707. On the other hand, if the stop of the cooling operation is not permitted (that is, the processing conducted immediately before S706 is S807, or the result of determination that the stop of the cooling operation is not permitted is maintained in S808), the CPU 41 executes processing of S710.

In S707, the CPU 41 obtains information indicating the operation statuses of the printing control unit 44 and the ink supply control unit 47 by using a publicly-known method, and based on the information, determines whether or not the cooling operation is being executed.

If the printing control unit 44, the ink supply control unit 47, or both of these are in operation (YES in S707), the CPU 41 executes processing of S708. On the other hand, both of the printing control unit 44 and the ink supply control unit 47 are not in operation (NO in S707), the CPU 41 executes processing of S713. In this case, the stop state of the cooling operation is maintained, and the count of the first timer is continued. In S708, the CPU 41 stops the cooling operation.

In S709, the count of the first timer is returned to “0”, and a new count is started in order to count the stop time of the cooling operation.

In S710, the CPU 41 obtains information indicating the operation statuses of the printing control unit 44 and the ink supply control unit 47 by using a publicly-known method, and based on the information, determines whether or not the cooling operation is being executed. If the cooling operation is being executed (YES in S710), the CPU 41 executes processing of S713. In this case, the cooling operation is continued, and the count of the first timer is also continued. On the other hand, if the cooling operation is not being executed (NO in S710), the CPU 41 executes processing of S711.

In S711, the CPU 41 starts the cooling operation.

In S712, the CPU 41 returns the count of the first timer to “0”, and starts a new count in order to count the execution time of the cooling operation.

In S713, the CPU 41 determines whether or not the time elapsed after the completion of the printing operation is longer than a predetermined time. Specifically, the CPU 41 reads the memory 42, and obtains a second elapsed time t2 counted by the second timer and a first time (tMAX). Then, the CPU 41 compares the second elapsed time t2 and the first time (tMAX), and determines whether or not the second elapsed time t2 is longer than the first time (tMAX). The first time (tMAX) is time which can be set by the user as desired.

In the present embodiment, the first time (tMAX) is 30 minutes. If the second elapsed time t2 is equal to or less than 30 minutes (NO in S713), the CPU 41 executes processing of S714. On the other hand, if the time elapsed after the completion of the printing operation exceeds 30 minutes (YES in S713), the CPU 41 executes processing of S715.

In S714, the CPU 41 stands by for a predetermined time (Δt). In the present embodiment, the predetermined time (Δt) is 1 minute. According to this configuration, the processing time in the case of repeatedly conducting the processing from S705 to S713 through S714 can be ensured. After S714, the CPU 41 executes the processing of S705 again.

In S715, the CPU 41 obtains information indicating the operation statuses of the printing control unit 44 and the ink supply control unit 47 by using a publicly-known method, and based on the information, determines whether or not the cooling operation is being executed. If the cooling operation is being executed (YES in S715), the CPU 41 executes processing of S716. On the other hand, if the cooling operation is not being executed (NO in S715), the CPU 41 ends the processing of the present flowchart.

In S716, the CPU 41 stops the cooling operation. After S716, the CPU 41 ends the processing of the present flowchart.

As described above, in the present embodiment, for example, in the case where the difference between the temperature of the printing unit 8 and the temperature of the ink in the circulation flow passages is less than 3° C., and the time elapsed from the time point of completion of the printing operation exceeds 30 minutes, the stop of the cooling operation is permitted. Alternatively, in the case where the difference between the temperature of the printing unit 8 and the temperature of the ink in the circulation flow passage is equal to or more than 3° C., the difference between the current temperature in the printing unit 8 and the temperature 3 minutes earlier is smaller than 0.5° C., and the time elapsed from the time point of the completion of the printing operation exceeds 30 minutes as well, the stop of the cooling operation is permitted. This is because it can be judged that the temperature in the circulation flow passages will not be largely change after this. On the other hand, if the above-described conditions are not satisfied, there is still a possibility that the temperature in the circulation flow passages changes, so that the stop of the cooling operation is not permitted.

That is, in the present embodiment, in the case where there is a high possibility that the temperature of the printing unit 8 has sufficiently decreased, the stop of the cooling operation is permitted. On the other hand, in the case where these is a low possibility that the temperature of the printing unit 8 has sufficiently decreased, the stop of the cooling operation is no permitted, and the cooling operation is executed.

In this way, a large increase in temperature of the inks in the circulation flow passages after the completion of the printing operation is suppressed. Hence, it is possible to suppress aggregation of the inks in the circulation flow passages. Moreover, since an unnecessary cooling operation is not executed, it is also possible to suppress the shortening of service lives of the suction fans 33, the exhaust fans 34, the board cooling fans 36, the upstream circulation pump 55, and the downstream circulation pump 56 (see FIG. 2 and the like), and suppress the consumption of the electric power.

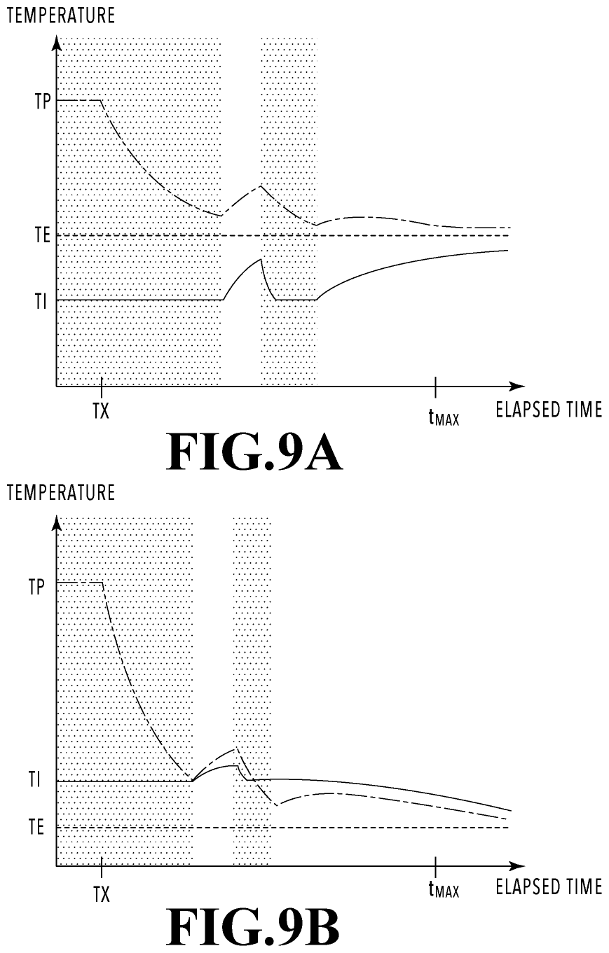

FIG. 9A and FIG. 9B are graphs showing different transitions of the output values of the first temperature sensor 32 and the second temperature sensor 61 in the present embodiment. FIG. 9A shows temperature transitions in the case where the circulation flow passage temperature TI is lower than the environmental temperature TE. FIG. 9B shows temperature transitions in the case where the circulation flow passage temperature TI is equal to or more than the environmental temperature TE.

In both cases of FIG. 9A and FIG. 9B, the head temperature TP is kept substantially constant and the circulation flow passage temperature TI is kept at the circulation setting temperature TC during the printing operation as in the case of FIG. 6. Then, immediately after the completion of the printing operation, the head temperature TP is relatively high, and the cooling operation is continued while the elapsed time is relatively short (NO in S803 and YES in S804). At this time, since the amount of heat dissipated from the head control board 49 (see FIG. 2), the first drying unit 10, and the second drying unit 11 (see FIG. 1) gradually decreases, the head temperature TP decreases to be closer to the environmental temperature TE with the elapse of time. On the other hand, during the cooling operation, the circulation flow passage temperature TI is kept at the circulation setting temperature TC.

As shown in FIG. 9A, during the cooling operation, the head temperature TP gradually comes closer to the environmental temperature TE, and an amount of change in the head temperature TP becomes smaller with the elapse of time. If the value obtained by subtracting the circulation flow passage temperature TI from the head temperature TP becomes less than the first temperature difference (Tth1), the stop of the cooling operation is permitted (S806). That is, in the case where the difference between the head temperature TP and the circulation flow passage temperature TI is sufficiently small, it is determined that amounts of increases of the head temperature TP and the circulation flow passage temperature TI are small even if the cooling operation is stopped.

If the value obtained by subtracting the circulation flow passage temperature TI from the head temperature TP is equal to or more than the first temperature difference (Tth1), it is determined whether or not the time elapsed from the completion of the printing operation is equal to or more than the second time (tmin) (S804). If the time elapsed from the completion of the printing operation is equal to or more than the second time (tmin) (YES in S804), it is determined whether or not an amount of change in temperature of the printing unit 8 during the second time (tmin) is lower than the second temperature difference Tth2 (S805).

If the cooling operation has proceeded and the change in temperature of the printing unit 8 has become small (YES in S805), the stop of the cooling operation is permitted (S806). On the other hand, if not (NO in S805), the cooling operation is continued (S807). After the cooling operation is stopped, the head temperature TP slightly increases depending on amounts of decreases in temperature in the head control board 49, the first drying unit 10, and the second drying unit 11.

In addition, after the cooling operation is stopped, the circulation flow passage temperature TI comes closer to the head temperature TP. In the case where an increase in the head temperature TP at this time is large, there is a possibility that the circulation flow passage temperature TI exceeds the environmental temperature TE and increases to a large extent. For this reason, if an amount of change in temperature of the printing unit 8 during the second time (tmin) is equal to or more than the second temperature difference Tth2 (NO in S805), the stop of the cooling operation is not permitted (S807). Once the cooling operation is started again, the head temperature TP and the circulation flow passage temperature TI decrease, and the cooling operation is continued until a fluctuation in temperature becomes small.

In this way, by repeating the temperature determination processing until the amount of increase in the head temperature TP after the stop of the cooling operation becomes less than the second temperature difference Tth2, an increase in the circulation flow passage temperature TI after the stop of the cooling operation is suppressed.

If the circulation flow passage temperature TI is equal to or more than the environmental temperature TE, processing different from that in the case where the circulation flow passage temperature TI is less than the environmental temperature TE is conducted.

As shown in FIG. 9B, if the head temperature TP is lowered by the cooling operation, the difference between the head temperature TP and the circulation flow passage temperature TI becomes less than the first temperature difference (Tth1) at a certain time point. That is, since the circulation flow passage temperature TI has come sufficiently close to the head temperature TP (YES in S803), the stop of the cooling operation is permitted (S806).

In the case where the heat sources have not been sufficiently cooled down after the cooling operation is stopped, the head temperature TP increases again. However, the cooling operation is repeated (S806) until the processing of S805, which is conducted again, becomes a negative result of determination (until NO is obtained in S805). By repeating such processing, after the first time (tMAX) has elapsed from the time point TX of completion of the printing operation, the state in which the head temperature TP is lower than the circulation flow passage temperature TI continues even in the case where the cooling operation has been stopped. As such a state continues, an increase in the circulation flow passage temperature TI is suppressed.

As described above, according to the printing apparatus 1 of the present embodiment, the stop of the cooling operation (for example, ventilation of the printing unit 8) is permitted in the case where a temperature difference between the printing unit and the inside of the ink passages is less than a predetermined value (for example, 3° C.).

Alternatively, even in the case where the difference between the head temperature TP and the circulation flow passage temperature TI is equal to or more than the first temperature difference (Tth1), if the time counted by a timer is equal to or less than a certain time and an amount of change in temperature of the printing unit during the certain time is less than a predetermined value, the stop of the cooling operation is permitted.

For example, in the case where the temperature difference between the printing unit and the inside of the ink passages is equal to or more than the predetermined value, if the elapsed time after the count by the first timer is started is equal to or less than 3 minutes and the amount of change in temperature of the printing unit during the 3 minutes is less than 0.5° C., the stop of the cooling operation is permitted. Then, upon satisfying the above-described conditions, in the case where the elapsed time after the count by the first timer is started has exceeded a certain time (for example, 30 minutes), the cooling operation is stopped. On the other hand, in the case where the above-described conditions are not satisfied, the stop of the cooling operation is not permitted, and the cooling operation is conducted.

Hence, according to the printing apparatus 1 of the present embodiment, an event in which the temperatures of the printing unit and the flow passages increase after the completion of the printing operation, and the ink remaining in the inside of these aggregates to generate a solid aggregate is suppressed.

Therefore, according to the printing apparatus 1 of the present embodiment, it is possible to suppress change in properties of an ink after the completion of a printing operation.

### Second Embodiment

Hereinafter, a second embodiment in the technology of the present disclosure will be described with reference to the drawings. An object of the present embodiment is to provide a printing apparatus 1 which can suppress change in properties of an ink after the completion of a printing operation with higher accuracy. In the following description, the same or corresponding configurations as or to those in the first embodiment are denoted by the same signs, and description thereof is omitted, and different points are mainly described.

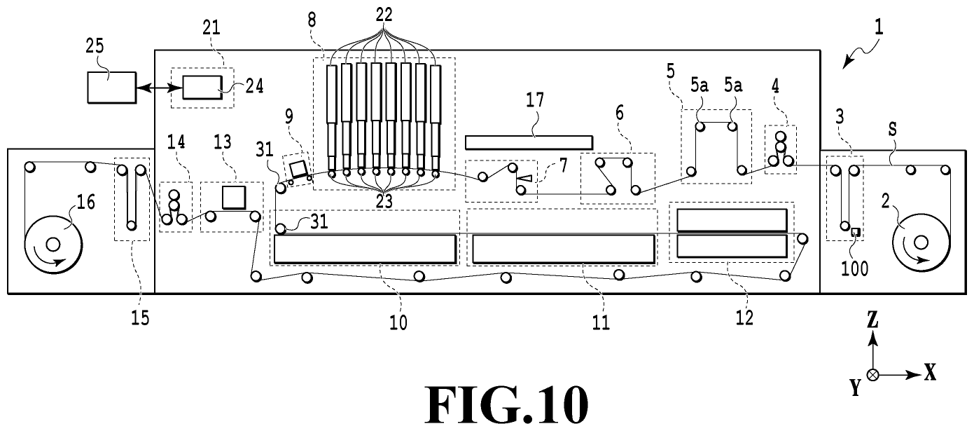

FIG. 10 is a schematic sectional view showing an internal configuration of a printing apparatus 1 which can be applied to the present embodiment.

As shown in FIG. 10, the printing apparatus 1 includes a first dancer unit 3. The first dancer unit 3 of the present embodiment includes an environmental temperature sensor 100 for measuring an environmental temperature around the printing apparatus 1.

Note that the position at which to provide the environmental temperature sensor 100 is not limited to the first dancer unit 3 as long as the position is not influenced by heat generated by the printing operation. For example, the environmental temperature sensor 100 may be provided in the unwinding roll unit 2. However, it is preferable not to provide the environmental temperature sensor 100 in a heat source (for example, the printing unit 8, the first drying unit 10, or the second drying unit 11).

In addition, it is also preferable not to provide the environmental temperature sensor 100 at a position which is influenced by air blow of the suction fans 33, the exhaust fans 34, and the board cooling fans 36. This is because if the environmental temperature sensor 100 is provided at any of these positions, the environmental temperature sensor 100 is influenced by heat generation or heat exhaustion occurring at the time of a printing operation, making it difficult to detect a correct environmental temperature around the printing apparatus 1.

In addition, it is also preferable not to provide the environmental temperature sensor 100 downstream of the first drying unit 10 (for example, in the winding roll unit 16) in the conveyance passage of the printing medium S. This is because if the environmental temperature sensor 100 is provided at this position, the environmental temperature sensor 100 is influenced by the printing medium S heated by the first drying unit 10 or the like, making it difficult to detect a correct environmental temperature inside the printing apparatus 1.

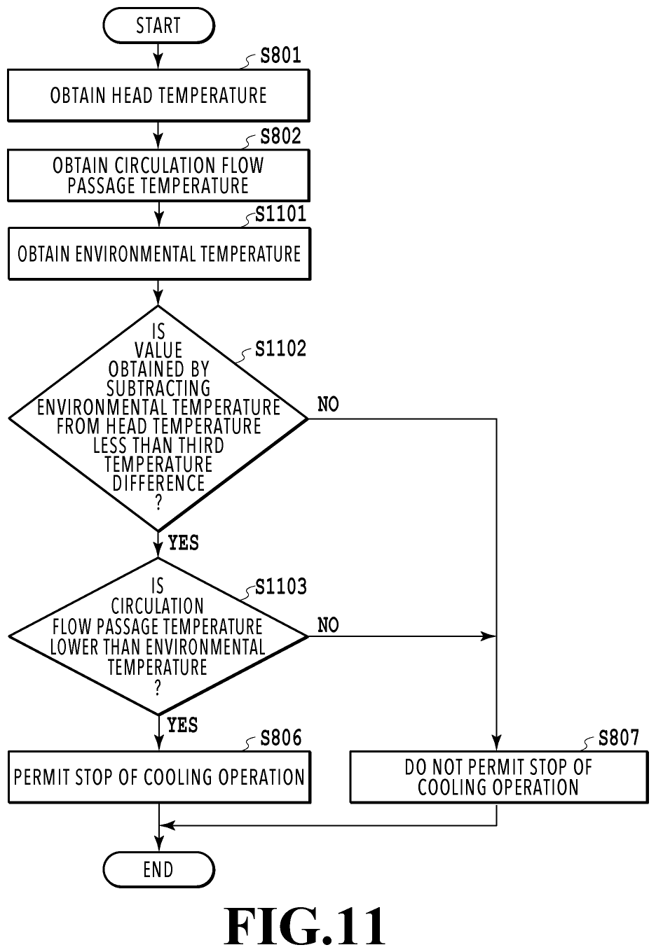

FIG. 11 is a flowchart showing a subroutine of S705 which can be applied to the present embodiment.

As shown in FIG. 11, in S705 (see FIG. 7) of the present embodiment, the flowchart of FIG. 11 is conducted in place of the flowchart shown in FIG. 8. In the present embodiment, after S802, processing of S1101 is conducted by the CPU 41 (see FIG. 2).

In S1101, the CPU 41 (see FIG. 2) obtains an environmental temperature TE.

In S1102, the CPU 41 compares a temperature obtained by subtracting the environmental temperature TE from the head temperature TP and a third temperature difference (Tth3), and determines whether or not the value obtained by subtracting the environmental temperature TE from the head temperature TP is less than the third temperature difference (Tth3). For example, the CPU 41 determines whether or not the temperature obtained by subtracting the environmental temperature TE from the head temperature TP is less than 4° C. However, an example of the third temperature difference (Tth3) is not limited to 4° C. For example, the third temperature difference (Tth3) may be set within a range of 3° C. or more and 5° C. or less as appropriate.

If the temperature obtained by subtracting the environmental temperature TE from the head temperature TP is less than the third temperature difference (Tth3) (YES in S1304), the CPU 41 executes processing of S1103. On the other hand, if the temperature obtained by subtracting the environmental temperature TE from the head temperature TP is equal to or more than the third temperature difference (Tth3) (NO in S1304), the CPU 41 executes processing of S807.

In S1103, the CPU 41 determines whether or not the circulation flow passage temperature TI is lower than the environmental temperature TE. If the circulation flow passage temperature TI is lower than the environmental temperature TE, the CPU 41 executes processing of S806. On the other hand, if the circulation flow passage temperature TI is equal to or more than the environmental temperature TE, the CPU 41 executes processing of S807.

As described above, in the present embodiment, in the case of determining whether or not the cooling operation can be stopped, the environmental temperature TE is also considered as a determination factor besides the head temperature TP and the circulation flow passage temperature TI.

Hence, in the case where there is a possibility that the temperature of the inks is increased by an influence of the environmental temperature TE after the completion of the printing operation, the stop of the cooling operation is not permitted.

Therefore, according to the printing apparatus 1 of the present embodiment, it is possible to suppress change in properties of an ink after the completion of a printing operation with higher accuracy.

### Modification of Second Embodiment

In the above-described S1103, it is determined whether or not the circulation flow passage temperature TI is lower than the environmental temperature TE. However, an example of the comparison target for the circulation flow passage temperature TI is not limited to the environmental temperature TE.

For example, a circulation setting temperature TC set by the user may be obtained by the CPU 41 to allow the CPU 41 to determine whether or not the circulation flow passage temperature TI is equal to or less than the circulation setting temperature TC. Then, the CPU 41 may execute the processing of S806 if the circulation flow passage temperature TI is equal to or less than the circulation setting temperature TC, and the CPU 41 may execute the processing of S807 if the circulation flow passage temperature TI is larger than the circulation setting temperature TC.

On the other hand, if the circulation setting temperature TC is higher than the circulation flow passage temperature TI and the environmental temperature TE, there is the smallest possibility that the temperature of the inks becomes higher than the circulation setting temperature TC (for example, 22° C.) (see FIG. 9B).

Hence, in this case, even if the stop of the cooling operation is permitted, there is a small possibility that the properties of the inks change.

Therefore, such a configuration also makes it possible to suppress change in properties of the inks after the completion of the printing operation with higher accuracy.

### Other Embodiments

In the first and second embodiments, the plurality of printing heads 22 are provided inside one printing unit 8. However, the inside of one printing unit 8 may be divided into a plurality of sections. Then, the printing heads 22, the upstream circulation pumps 55, the downstream circulation pumps 56, the suction fans 33, the exhaust fans 34, and the like may be provided in each section. In this configuration, the first temperature sensor 32 detects the temperature of each of the plurality of sections. Then, the CPU 41 controls the drives of the upstream circulation pumps 55, the downstream circulation pumps 56, the suction fans 33, the exhaust fans 34, and the like for each of the plurality of sections.

According to this configuration, since the temperature of a narrower range can be obtained, it is possible to suppress change in properties of the inks after the completion of the printing operation with higher accuracy.

In addition, the first and second embodiments have been described on the assumption that the printing apparatus 1 is a line-type inkjet printer including the printing heads 22 having a size equal to or larger than the width of the printing medium S. However, as long as the printing apparatus is configured to be capable of comparing the temperature of an ink in a circulation passage and a surrounding environmental temperature, the technology of the present disclosure can be applied to a serial-type inkjet printer which conducts printing while reciprocating along the scanning direction.

In addition, in the first and second embodiments, inks are used as the liquid, the liquid which can be used in the technology of the present disclosure is not limited to an ink. Besides inks, various printing liquids including processing liquids to be used for the purpose of improving the fixation of an ink, reducing a gloss unevenness, and improving a scratch resistance in a printing medium, and the like can be used as the liquid.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the technology of the present disclosure, it is possible to suppress change in properties of an ink after the completion of a printing operation.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-151303, filed Sep. 3, 2024, which is hereby incorporated by reference herein in its entirety.

What is claimed is:

1. A printing apparatus comprising:
a printing head including a printing element configured to generate an energy for ejecting a liquid;
a liquid reservoir unit configured to reserve the liquid;
a supply passage configured to supply the liquid from the liquid reservoir unit to the printing head;
a circulation flow passage configured to include at least part of the supply passage, supply the liquid from the liquid reservoir unit to the printing head through the supply passage, and cause the liquid passed through the print head to again pass through the supply passage;
a circulation drive unit configured to circulate the liquid in the circulation flow passage;
a ventilation unit configured to ventilate an atmosphere inside a printing unit provided with the printing head and the circulation flow passage;
a first temperature detection unit configured to detect a temperature of the printing unit;
a second temperature detection unit configured to detect a temperature of the liquid in the circulation flow passage; and
a control unit configured to control drive of the circulation drive unit and drive of the ventilation unit, wherein
in a case where a difference between the temperature detected by the first temperature detection unit and the temperature detected by the second temperature detection unit is equal to or more than a first temperature difference, and a first time has not elapsed from completion of a printing operation of the printing head, the control unit drives the circulation drive unit and the ventilation unit.

2. The printing apparatus according to claim 1, wherein
in a case where the difference between the temperature detected by the first temperature detection unit and the temperature detected by the second temperature detection unit is less than the first temperature difference, and the first time has elapsed from the completion of the printing operation of the printing head, the control unit stops the circulation drive unit and the ventilation unit.

3. The printing apparatus according to claim 1, wherein
in a case where the first time has not elapsed from the completion of the printing operation of the printing head, and a difference between a temperature of the printing unit at a current time point and a temperature of the printing unit at a time point which is earlier than the current time point by a second time is less than a second temperature difference, the control unit stops the circulation drive unit and the ventilation unit.

4. The printing apparatus according to claim 3, wherein
in a case where the first time has not elapsed from the completion of the printing operation of the printing head, and the difference between the temperature of the printing unit at the current time point and the temperature of the printing unit at the time point which is earlier than the current time point by the second time is equal to or more than the second temperature difference, the control unit drives the circulation drive unit and the ventilation unit.

5. A printing apparatus comprising:
a printing head including a printing element configured to generate an energy for ejecting a liquid;
a liquid reservoir unit configured to reserve the liquid;
a supply passage configured to supply the liquid from the liquid reservoir unit to the printing head;
a circulation flow passage configured to include at least part of the supply passage, supply the liquid from the liquid reservoir unit to the printing head through the supply passage, and cause the liquid passed through the print head to again pass through the supply passage;
a circulation drive unit configured to circulate the liquid in the circulation flow passage;
a ventilation unit configured to ventilate an atmosphere inside a printing unit provided with the printing head and the circulation flow passage;
a first temperature detection unit configured to detect a temperature of the printing unit;
a second temperature detection unit configured to detect a temperature of the liquid in the circulation flow passage;
a third temperature detection unit configured to detect an environmental temperature around the printing unit; and
a control unit configured to control drive of the circulation drive unit and drive of the ventilation unit, wherein
in a case where a first time has not elapsed from completion of a printing operation of the printing head, a difference between the environmental temperature detected by the third temperature detection unit and the temperature detected by the second temperature detection unit is less than a third temperature difference, and the temperature detected by the first temperature detection unit is lower than the environmental temperature detected by the third temperature detection unit, the control unit stops the circulation drive unit and the ventilation unit.

6. The printing apparatus according to claim 5, wherein
in a case where the first time has not elapsed from the completion of the printing operation of the printing head, and the difference between the environmental temperature detected by the third temperature detection unit and the temperature detected by the second temperature detection unit is equal to or more than the third temperature difference, the control unit drives the circulation drive unit and the ventilation unit.

7. The printing apparatus according to claim 5, wherein
an inside of the printing unit includes a plurality of sections,
the printing head, the circulation drive unit, and the ventilation unit are provided in each of the plurality of sections,
the second temperature detection unit detects a temperature of each section, and
the control unit controls the drives of the circulation drive unit and the ventilation unit for each of the plurality of sections.

8. The printing apparatus according to claim 1, comprising:
a plurality of sets of the circulation flow passages and the first temperature detection units, wherein
in a case where a difference between the temperature detected by the second temperature detection unit and a highest temperature among the temperatures detected by the plurality of first temperature detection units is equal to or more than the first temperature difference, and the first time has not elapsed from the completion of the printing operation of the printing head, the control unit drives the circulation drive unit and the ventilation unit.

9. The printing apparatus according to claim 1, wherein the liquid is an ink containing a thermoplastic resin.

10. The printing apparatus according to claim 1, wherein
the circulation flow passage includes:
a first flow passage configured to supply the liquid from the liquid reservoir unit to the printing head; and
a second flow passage configured to collect the liquid from the printing head to the liquid reservoir unit, and
the circulation drive unit includes:
a first pump provided in the first flow passage and configured to supply the liquid from the liquid reservoir unit to the printing head; and
a second pump provided in the second flow passage and configured to collect the liquid from the printing head to the liquid reservoir unit.

11. The printing apparatus according to claim 1, wherein
the ventilation unit includes:
a suction fan configured to suck the atmosphere from an outside of the printing unit to an inside thereof; and
an exhaust fan configured to exhaust the atmosphere from the inside of the printing unit to the outside thereof.

12. The printing apparatus according to claim 1, further comprising:
a temperature adjustment unit configured to adjust the liquid in the circulation flow passage into a predetermined temperature range, wherein
the control unit drives the temperature adjustment unit together with the circulation drive unit.

13. The printing apparatus according to claim 12, wherein
the temperature adjustment unit is a heat exchanger.

14. The printing apparatus according to claim 5, further comprising:
a temperature adjustment unit configured to adjust the liquid in the circulation flow passage into a predetermined temperature range, wherein
the control unit drives the temperature adjustment unit together with the circulation drive unit.

15. The printing apparatus according to claim 14, wherein
the temperature adjustment unit is a heat exchanger.
